(19) United States
(12) Patent Application Publication
(10) Pub. No.: US 2017/0101561 A1
(43) Pub. Date: Apr. 13, 2017

(54) ADHESIVE COMPOSITION AND POLARIZING PLATE COMPRISING SAME

(71) Applicant: DONGWOO FINE-CHEM CO., LTD., Iksan-si, Jeollabuk-do (KR)

(72) Inventors: Han Young CHOI, Pyeongtaek-si (KR); Minkeun YOO, Seoul (KR)

(73) Assignee: DONGWOO FINE-CHEM CO., LTD., Iksan-si, Jeollabuk-do (KR)

(21) Appl. No.: 15/128,151

(22) PCT Filed: Mar. 23, 2015
(86) PCT No.: PCT/KR2015/002794

§ 371 Date: Sep. 22, 2016

(30) Foreign Application Priority Data
Mar. 26, 2014 (KR) 10-2014-0035213

(51) Int. Cl. C09J 133/08; G02F 1/1335; B32B 7/12; G02B 5/30

(52) U.S. Cl. CPC C09J 133/08; G02B 5/3025; G02F 1/133528; B32B 7/12; C08K 5/54

(57) ABSTRACT

The present invention provides an adhesive composition comprising an acrylic copolymer, a cross-linking agent, a silane coupling agent, and a strong acid with a pKa of 3 or less, a polarizing plate and a liquid crystal display device comprising the adhesive composition. The adhesive composition according to the present invention has high adhesive strength and excellent durability.

### TECHNICAL FIELD

The present invention relates to an adhesive composition and a polarizing plate comprising the same. Particularly, the present invention provides an adhesive composition having high adhesive strength and excellent durability, a polarizing plate comprising the adhesive composition, and a liquid crystal display device having the polarizing plate.

### BACKGROUND ART

A liquid crystal display device (LCD) has a liquid crystal panel including a liquid crystal cell and polarizing plates laminated on both sides of the liquid crystal cell through adhesive layers.

The adhesive used to attach the polarizing plates to the liquid crystal cell should simultaneously satisfy durability such as heat resistance, heat/moisture resistance, thermal shock resistance and cold resistance, reworkability for solving contact error or the presence of foreign substances, prevention of light leakage that is generated by the shrinkage stress of the polarizing plates, and antistatic property for preventing electrostatic generation while a release film is removed for adhesion of the polarizing plates. Among these properties, the characteristics of the adhesive for achieving the durability and the reworkability conflict with each other. Therefore, both physical properties could not have been completely satisfied.

In order to provide good adhesion of the adhesive to a substrate, a technique adding a silane coupling agent to the adhesive was proposed. Japanese Patent Application Publication No. (Hei) 4-223403 discloses an adhesive composition comprising a silane compound that has an epoxy group such as 3-glycidoxypropyltrimethoxysilane. However, the adhesive composition has insufficient adhesion and durability in actual applications.

### DISCLOSURE

### Technical Problem

It is an object of the present invention to provide an adhesive composition comprising a strong acid with a pKa of 3 or less to have high adhesive strength and excellent durability.

It is another object of the present invention to provide a polarizing plate including an adhesive layer comprising the adhesive composition.

It is still another object of the present invention to provide a liquid crystal display device having the polarizing plate on at least one surface of a liquid crystal cell.

### Technical Solution

In accordance with one aspect of the present invention, there is provided an adhesive composition, comprising an acrylic copolymer, a cross-linking agent, a silane coupling agent, and a strong acid with a pKa of 3 or less.

In one embodiment of the present invention, the strong acid with a pKa of 3 or less comprises oxalic acid or p-toluenesulfonic acid.

In accordance with another aspect of the present invention, there is provided a polarizing plate including an adhesive layer comprising the adhesive composition.

In accordance with still another aspect of the present invention, there is provided a liquid crystal display device having the polarizing plate on at least one surface of a liquid crystal cell.

### Advantageous Effects

The adhesive composition of the present invention increases the activity of the silane coupling agent by action of the strong acid, thereby largely enhancing adhesive strength and easily providing excellent durability.

### BEST MODE

The present invention is, hereinafter, described in more detail.

One embodiment of the present invention relates to an adhesive composition, comprising an acrylic copolymer, across-linking agent, a silane coupling agent, and a strong acid with a pKa of 3 or less.

In one embodiment of the present invention, the acrylic copolymer is an adhesive resin, which may be a copolymer of an late monomer having a C₁₋₁₂ alkyl group and a monomer having a cross-linkable functional group. As used herein, the term ‘(meth)acrylate’ refers to acrylate and methacrylate.

Examples of the (meth)acrylate monomer having a C₁₋₁₂ alkyl group may include n-butyl(meth)acrylate, 2-butyl (meth)acrylate, t-butyl (meth)acrylate, 2-ethythexyl (meth)acrylate, 2-ethylbutyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, n-nonyl (meth)acrylate, isononyl (meth)acrylate, decyl(meth)acrylate, lauryl (meth)acrylate, etc. These monomers may be used alone or in combination of two or more. Among them, n-butyl acrylate, 2-ethylhexyl acrylate, and a mixture thereof are preferred.

The (meth)acrylate monomer having a C₁₋₁₂ alkyl group is preferably present in an amount of 80 to 99 wt %, more preferably 90 to 95 wt %, based on 100 wt % of the total monomers used in the preparation of the acrylic copolymer. If the amount of the (meth)acrylate monomer is less than 80 wt %, the adhesive strength may be insufficient. If the amount of the (meth)acrylate monomer is more than 99 wt %, the cohesive strength may be lowered.

The monomer having a cross-linkable functional group is used to give cohesive strength or adhesive strength through chemical bonding with a cross-linking agent as described below, and it may include a monomer having a hydroxyl group, a monomer having a carboxyl group, a monomer having an amide group, a monomer having a tertiary amine group, etc. These monomers may be used alone or in combination of two or more.

Examples of the monomer having a hydroxyl group may include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethyleneglycol (meth)acrylate, 2-hydroxypropyleneglycol (meth)acrylate, hydroxyalkyleneglycol (meth)acrylate having a C₂₋₄ alkylene group, etc. Among them, 2-hydroxyethyl (meth)acrylate is preferred.

Examples of the monomer having a carboxyl group may include monobasic acids such as (meth)acrylic acid and crotonic acid; dibasic acids such as maleic acid, itaconic acid and fumaric acid, and monoalkylesters thereof; 3-(meth)acryloylpropionic acid; succinic anhydride ring-opening adducts of 2-hydroxyalkyl (meth)acrylate having a C₂₋₃ alkyl group, succinic anhydride ring-opening adducts of hydroxyalkyleneglycol (meth)acrylate having a C₂₋₄ alkylene group, compounds obtained by ring-opening addition of succinic anhydride to carprolactone adduct of 2-hydroxyalkyl (meth)acrylate having a C₂₋₃ alkyl group, etc. Among them, (meth)acrylic acid is preferred.

Examples of the monomer having an amide group may include (meth)acrylamide, N-isopropylacrylamide, N-tert-butylacrylamide, etc. Among them, (meth)acrylamide is preferred.

Examples of the monomer having a tertiary amine group may include N,N-(dimethylamino)ethyl (meth)acrylate, N,N-(diethylamino)ethyl (meth)acrylate, N,N-(dimethylamino)propyl (meth)acrylate, etc.

The monomer having a cross-linkable functional group is preferably present in an amount of 1 to 20 wt %, more preferably 1 to 10 wt %, based on 100 wt % of the total monomers used in the preparation of the acrylic copolymer. If the amount of the monomer having a cross-linkable functional group is less than 1 wt %, the cohesive strength may be lowered. If the amount of the monomer having a cross-linkable functional group is more than 20 wt %, the adhesive strength may be deteriorated.

In addition to the above monomers, other monomers may be further contained in a range not to degrade the adhesive strength, for example 10 wt % or less, preferably 5 wt % or less.

The copolymer can be prepared, without limitation, using bulk polymerization, solution polymerization, emulsion polymerization or suspension polymerization, etc. which are conventionally known in the art. Among them, the solution polymerization is preferred. Further, a solvent, a polymerization initiator, a chain transfer agent for controlling the molecular weight, etc. which are conventionally known in the art can be used for the polymerization.

The acrylic copolymer may have a polystyrene-converted weight average molecular weight of 50,000 to 2,000,000, preferably 1,000,000 to 2,000,000, as measured by gel permeation chromatography (GPC).

In one embodiment of the present invention, the cross-linking agent is used to enhance the cohesive strength of the adhesive by cross-linking the copolymer. By way of examples, the cross-linking agent may include, without limitation, isocyanate compounds, epoxy compounds, etc. These compounds may be used alone or in combination of two or more.

Examples of the isocyanate compounds may include diisocyanate compounds such as tolylene diisocyanate, xylene diisocyanate, 2,4-diphenylmethane diisocyanate, 4,4-diphenylmethane diisocyanate, hexamethylene diisocyanate, isophorone diisocyanate, tetramethylxylene diisocyanate, and naphthalene diisocyanate; and multifunctional isocyanate compounds having three functional groups such as adducts obtained by reacting 1 mol of polyhydric alcohol compounds such as trimethylolpropane with 3 mol of diisocyanate compounds, isocyanurates obtained by self-condensation of 3 mol of diisocyanate compounds, biurets obtained by condensation of diisocyanate ureas prepared from 2 mol of diisocyanate compounds with 1 mol of diisocyanate compound, triphenylmethane triisocyanate, and methylenebistriisocyanate.

Examples of the epoxy compounds may include ethyleneglycol diglycidyl ether, diethyleneglycol diglycidyl ether, polyethyleneglycol diglycidyl ether, propyleneglycol diglycidyl ether, tripropyleneglycol diglycidyl ether, polypropyleneglycol diglycidyl ether, neopentylglycol diglycidyl ether, 1,6-hexanediol diglycidyl ether, polytetramethyleneglycol diglycidyl ether, glycerol diglycidyl ether, glycerol triglycidyl ether, diglycerol polyglycidyl ether, polyglycerol polyglycidyl ether, resorcin diglycidyl ether, 2,2-dibromoneopentylglycol diglycidyl ether, trimethylolpropane triglycidyl ether, pentaerythritol polyglycidyl ether, sorbitol polyglycidyl ether, adipic acid diglycidyl ester, phthalic acid ester, tris(glycidyl)isocyanurate, tris(glycidoxyethyl)isocyanurate, 1,3-bis(N,N-glycidylaminomethyl)cyclohexane, N,N,N′,N′-tetraglycidyl-m-xylylenediamine, etc.

In addition to the isocyanate compounds and epoxy compounds, melamine compounds may be further used alone or in combination of two or more.

Examples of the melamine compounds may include hexamethylolmelamine, hexamethoxymethylmelamine, hexabutoxymethylmelamine, etc.

The cross-linking agent may be preferably contained in an amount of 0.1 to 15 parts by weight, more preferably 0.1 to 5 parts by weight, based on 100 parts by weight of the acrylic copolymer. If the amount of the cross-linking agent is less than 0.1 parts by weight, the cohesive strength may be decreased due to insufficient cross-linking, thereby resulting in durability deterioration such as lifting and damaging cutting property. If the amount of the cross-linking agent is more than 15 parts by weight, the residual stress cannot be sufficiently relaxed due to excessive cross-linking.

In one embodiment of the present invention, the silane coupling agent is used to enhance adhesion of the adhesive to a substrate, and it may be an alkoxysilane containing a functional group such as amino, epoxy, acetoacetyl, polyalkylene glycol, acrylic and alkyl group, preferably an epoxy-containing silane coupling agent.

Specific examples of the silane coupling agent may include vinylchlorosilane, vinyltrimethoxysilane, vinyltriethoxysilane, 2-(3,4-epoxycyclohexyl)ethyltrimethoxysilane, 3-glycidoxypropyltrimethoxysilane, 3-glycidoxypropylmethyldiethoxysilane, 3-glycidoxypropyldiethoxysilane, 3-glycidoxypropyltriethoxysilane, p-styryltrimethoxysilane, 3-methacryloxypropyltriethoxysilane, 3-methacryloxypropyltrimethoxysilane, 3-methacryloxypropylmethyldimethoxysilane, 3-methacryloxypropylmethyldiethoxysilane, 3-acryloxypropyltrimethoxysilane, N-2-(aminoethyl)-3-aminopropylmethyldimethoxysilane, N-2-(aminoethyl)-3-aminopropyltrimethoxysilane, N-2-(aminoethyl)-3-aminopropylmethyltriethoxysilane, 3-aminopropyltrimethoxysilane, 3-aminopropyltriethoxysilane, 3-triethoxysilyl-N-(1,3-dimethylbutylidene)propylamine, N-phenyl-3-aminopropyltrimethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, 3-isocyanatopropyltriethoxysilane, etc., preferably epoxy-based silanes such as 2-(3,4-epoxycyclohexyl)ethyltrimethoxysilane, 3-glycidoxypropyltrimethoxysilane, 3-glycidoxypropylmethyldiethoxysilane, 3-glycidoxypropyldiethoxysilane and 3-glycidoxypropyltriethoxysilane. These compounds may be used alone or in combination of two or more.

The silane coupling agent is preferably present in an amount of 0.01 to 2 parts by weight, more preferably 0.01 to 0.5 parts by weight, based on 100 parts by weight of the acrylic copolymer. If the amount of the silane coupling agent is less than 0.01 parts by weight, the effect of increasing adhesion strength may be insufficient to cause peeling defects under heat-resistance conditions. If the amount of the silane coupling agent is more than 2 parts by weight, the effect of increasing adhesion strength may be deteriorated.

In one embodiment of the present invention, the strong acid may be any acids if it has a pKa of 3 or less, preferably an organic acid with a pKa of 3 or less when considering the solubility in an organic solvent. Specific examples of the strong acid may include an acetic acid derivative with an electron withdrawing substituent, such as oxalic acid, nitroacetic acid and chloroacetic acid; an organic sulfonic acid such as p-toluenesulfonic acid, benzenesulfonic acid, methanesulfonic acid and trifluoromethanesulfonic acid; and an organic phosphoric acid derivative such as phenylphosphonic acid. Among these, oxalic acid and p-toluenesulfonic acid are preferred.

The strong acid is preferably present in an amount of 0.001 to 0.1 parts by weight based on 100 parts by weight of the acrylic copolymer. If the amount of the strong acid is less than 0.001 parts by weight, the effect of increasing adhesion strength may be insufficient. If the amount of the strong acid is more than 0.1 parts by weight, the cohesion strength may be lowered due to an insufficient gel fraction.

The adhesive composition according to one embodiment of the present invention, if necessary, may further comprise an additive such as an adhesion enhancing resin, an antioxidant, a leveling agent, a surface lubricant, a dye, a pigment, a defoaming agent, a filler, a light stabilizer, and an antistatic agent in order to control adhesion, cohesion, viscosity, elasticity, glass transition temperature, antistatic property, etc.

The adhesive composition of the present invention may be used for an adhesive for attaching a polarizing plate with a liquid crystal cell and an adhesive for a surface protective film. Also, the adhesive composition may be used for an adhesive for a protective film, a reflective sheet, an adhesive sheet for structures, an adhesive sheet for photographs, an adhesive sheet for traffic lanes, optical adhesive products, electronic parts, general adhesive sheet products, and medical patches.

One embodiment of the present invention relates to a polarizing plate including an adhesive layer comprising the adhesive composition as described above.

The thickness of the adhesive layer may vary depending on its adhesive strength, and may preferably range from 3 to 100 μm, more preferably 10 to 100 μm.

Such a polarizing plate may be applied to typical liquid crystal display devices. Particularly, the polarizing plate may be used to fabricate a liquid crystal display device including a liquid crystal panel wherein the polarizing plate having the adhesive layer is laminated on at least one side of a liquid crystal cell.

Therefore, one embodiment of the present invention relates to a liquid crystal display device having the polarizing plate on at least one side of a liquid crystal cell.

The present invention is further illustrated by the following examples, comparative examples and experimental examples, which are not to be construed to limit the scope of the invention.

### Preparation Example 1

### Preparation of Acrylic Copolymer

To a 1 L reactor equipped with a cooler and subjected to nitrogen gas flow were added a monomer mixture consisting of 85 parts by weight of n-butyl acrylate (BA), 7 parts by weight of methyl acrylate (MA), 5 parts by weight of 2-hydroxyethyl acrylate and 3 parts by weight of acrylic acid, and then 100 parts by weight of ethyl acetate (EAc) as a solvent. Then, nitrogen gas was purged for 1 hour to remove oxygen, followed by maintaining the temperature to 62° C. After uniformly stirring the mixture, 0.07 parts by weight of azobisisobutyronitrile (AIBN) as a reaction initiator was added thereto, and the resulting mixture was reacted for 8 hours to give an acrylic copolymer having weight average molecular weight of about 1,000,000.

### Examples 1 to 12 and Comparative Examples 1 to 4

### Preparation of Adhesive-attached Polarizing Plate

The components listed in Table 1 were mixed to give an adhesive composition unit: parts by weight).

The adhesive composition thus obtained was applied on a silicon releasing agent-coated film so that the thickness is 25 μm after drying, and dried at 100° C. for 1 minute to form an adhesive layer. Thereon, another release film was laminated to give an adhesive sheet.

After peeling the release film from the adhesive sheet prepared above, the adhesive layer was attached to a 185 μm-thick iodine polarizing plate comprising a TAC protection film to prepare an adhesive-attached polarizing plate.

TABLE 1

| | | Cross-linking | Silane Coupling | |
|---|---|---|---|---|
| | Acrylic Copolymer | Agent | Agent | Strong Acid |
| Example 1 | Preparation Example | Coronate-L(0.5) | KBM-403(0.5) | C-1(0.001) |
| | 1(100) | | | |
| Example 2 | Preparation Example | Coronate-L(0.5) | KBM-403(0.5) | C-1(0.01) |
| | 1(100) | | | |
| Example 3 | Preparation Example | Coronate-L(0.5) | KBM-403(0.5) | C-1(0.1) |
| | 1(100) | | | |
| Example 4 | Preparation Example | Coronate-L(0.5) | KBM-403(0.5) | C-2(0.001) |
| | 1(100) | | | |
| Example 5 | Preparation Example | Coronate-L(0.5) | KBM-403(0.5) | C-2(0.01) |
| | 1(100) | | | |
| Example 6 | Preparation Example | Coronate-L(0.5) | KBM-403(0.5) | C-2(0.1) |
| | 1(100) | | | |
| Example 7 | Preparation Example | Coronate-L(0.5) | KBM-403(0.5) | C-2(0.15) |
| | 1(100) | | | |
| Example 8 | Preparation Example | Coronate-L(0.5) | KBM-4803(0.5) | C-2(0.001) |
| | 1(100) | | | |
| Example 9 | Preparation Example | Coronate-L(0.5) | KBM-403(0.1) | C-2(0.001) |
| | 1(100) | | | |
| Example | Preparation Example | Coronate-L(0.5) | KBM-403(0.01) | C-2(0.001) |
| 10 | 1(100) | | | |
| Example | Preparation Example | Coronate-L(0.5) | KBM-403(2.5) | C-2(0.001) |
| 11 | 1(100) | | | |
| Example | Preparation Example | D110N(0.5) | KBM-403(0.5) | C-2(0.001) |
| 12 | 1(100) | | | |
| Com. | Preparation Example | Coronate-L(0.5) | KBM-403(0.5) | — |
| Example 1 | 1(100) | | | |
| Com. | Preparation Example | Coronate-L(0.5) | KBM-4803(0.5) | — |
| Example 2 | 1(100) | | | |
| Com. | Preparation Example | Coronate-L(0.5) | KBM-403(0.5) | C-3(0.1) |
| Example 3 | 1(100) | | | |
| Com. | Preparation Example | Coronate-L(0.5) | KBM-403(0.5) | C-4(0.1) |
| Example 4 | 1(100) | | | |

Cross-linking Agent: Coronate-L (TDI/TMP Adduct, Nippon Polyurethane Industry) D110N (Adduct of xylene diisocyanate (XDI), Mitsui Chemicals, Inc.)
Silane Coupling Agent: KBM-403 (Shin-Etsu) KBM-4803 (Shin-Etsu)
C-1: Oxalic Acid (pKa = 2.83)
C-2: p-Toluenesulfonic Acid (pKa <0)
C-3: Benzoic Acid (pKa = 3.77)
C-4: Tridecanonic acid (pKa = 4.75)

### Experimental Example 1

### Evaluation of Adhesive Strength and Heat Resistance

The physical properties of the adhesive-attached polarizing plates prepared in the Examples and Comparative Examples were measured using the following methods, and the results were shown in Table 2.

(1) Adhesive Strength

The adhesive-attached polarizing plate was cut into a size of 25 mm×100 mm. After peeling the release film, the polarizing plate was laminated on a glass substrate at 0.25 MPa and was subject to autoclave-treatment under the conditions of 50° C., 490 pa and 20 minutes to give a sample.

The sample was left at 25° C., 50% RH for 24 hours and its adhesive strength was measured with peeling at a peel rate of 10 m/min and a peel angle of 180° using a universal testing machine (UTM, Instron). The measurement was performed at 25° C., 50% RH.

(2) Heat Resistance

After peeling the release film from the adhesive-attached polarizing plate, the plate was laminated on a glass (Corning Inc.), followed by autoclave treatment. After leaving at 85° C. for 300 hours, the occurrence of bubbles or peelings was observed.

<Evaluation Criteria>

x: at least 3 bubbles or peelings

Δ: not more than 2 bubbles or peelings

O: no bubble or peeling

TABLE 2

| | Adhesive Strength | |
|---|---|---|
| | (N/25 mm) | Heat Resistance |
| Example 1 | 8.7 | ◯ |
| Example 2 | 12.8 | ◯ |
| Example 3 | 21.5 | ◯ |
| Example 4 | 19.8 | ◯ |
| Example 5 | 22.0 | ◯ |
| Example 6 | 21.2 | ◯ |
| Example 7 | 20.0 | ◯ |
| Example 8 | 15.7 | ◯ |
| Example 9 | 18.2 | ◯ |
| Example 10 | 12.8 | ◯ |
| Example 11 | 6.9 | Δ |
| Example 12 | 22.3 | ◯ |
| Com. Example 1 | 3.1 | X |
| Com. Example 2 | 2.0 | X |
| Com. Example 3 | 3.2 | X |
| Com. Example 4 | 3.5 | X |

As shown in Table 2, the polarizing plates of Examples 1 to 12 using strong acids according to the present invention exhibited significantly superior adhesive strength and heat resistance, as compared with those of Comparative Examples 1 and 2 using only silane coupling agents and those of Comparative Examples 3 and 4 using weak acids.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

1. An adhesive composition, comprising an acrylic copolymer, a cross-linking agent, a silane coupling agent, and a strong acid with a pKa of 3 or less.

2. The adhesive composition of claim 1, wherein the silane coupling agent is present in an amount of 0.01 to 2 parts by weight based on 100 parts by weight of the acrylic copolymer.

3. The adhesive composition of claim 1, wherein the strong acid with a pKa of 3 or less is an organic acid.

4. The adhesive composition of claim 1, wherein the strong acid with a pKa of 3 or less is an acetic acid derivative, an organic sulfonic acid, or an organic phosphoric acid derivative.

5. The adhesive composition of claim 1, wherein the strong acid with a pKa of 3 or less is oxalic acid or p-toluenesulfonic acid.

6. The adhesive composition of claim 1, wherein the strong acid with a pKa of 3 or less is present in an amount of 0.001 to 0.1 parts by weight based on 100 parts by weight of the acrylic copolymer.

7. A polarizing plate including an adhesive layer comprising the adhesive composition of claim 1.

8. A liquid crystal display device having the polarizing plate of claim 7 on at least one side of a liquid crystal cell.

9. A polarizing plate including an adhesive layer comprising the adhesive composition of claim 2.

10. A liquid crystal display device having the polarizing plate of claim 9 on at least one side of a liquid crystal cell.

11. A polarizing plate including an adhesive layer comprising the adhesive composition of claim 3.

12. A liquid crystal display device having the polarizing plate of claim 11 on at least one side of a liquid crystal cell.

13. A polarizing plate including an adhesive layer comprising the adhesive composition of claim 4.

14. A liquid crystal display device having the polarizing plate of claim 13 on at least one side of a liquid crystal cell.

15. A polarizing plate including an adhesive layer comprising the adhesive composition of claim 5.

16. A liquid crystal display device having the polarizing plate of claim 15 on at least one side of a liquid crystal cell.

17. A polarizing plate including an adhesive layer comprising the adhesive composition of claim 6.

18. A liquid crystal display device having the polarizing plate of claim 17 on at least one side of a liquid crystal cell.
